(19) United States
(12) Patent Application Publication
(10) Pub. No.: US 2013/0025087 A1
(43) Pub. Date: Jan. 31, 2013

(54) LOW-FRICTION BUSH FOR VEHICLE

(71) Applicants: Dae Won Jang, Yongin-si (KR); Hee Gon Kang, Anyang-si (KR)

(72) Inventors: Dae Won Jang, Yongin-si (KR); Hee Gon Kang, Anyang-si (KR)

(73) Assignee: Hyundai Motor Company, Seoul (KR)

(21) Appl. No.: 13/276,971

(22) Filed: Oct. 19, 2011

(30) Foreign Application Priority Data
Jul. 29, 2011 (KR) 10-2011-0075537

(51) Int. Cl. F16L 5/02

(52) U.S. Cl. 16/2.2

(57) ABSTRACT

A low-friction bush for a vehicle may include an inner pipe having a spherical portion being convex toward the outside, a bearing seat configured to be in rolling contact with an outer surface of the spherical portion of the inner pipe, wherein each entrance of the bearing seat may be spaced from the spherical portion of the inner pipe, a sealing member sealingly mounted between each end of the inner pipe and the entrance of the bearing seat, a plastic housing integrally injection-molded on an outer surface of the bearing seat and an outer surface of the sealing member, an outer pipe spaced from an outer circumference of the plastic housing, and a vibration-proof rubber filled in a space between the outer pipe and the plastic housing to integrate the outer pipe and the plastic housing.

### CROSS-REFERENCE TO RELATED APPLICATION

The present application claims priority to Korean Patent Application No. 10-2011-0075537 filed Jul. 29, 2011, the entire contents of which is incorporated herein for all purposes by this reference.

### BACKGROUND OF THE INVENTION

1. Field of the Invention

The present invention relates to a low-friction bush for vehicle. More particularly, it relates to a low-friction bush for vehicle with a new structure, which is mounted on an arm or the like of a suspension system to provide a comfortable ride together with smooth movement of the wheels during vehicle driving.

2. Description of Related Art

Typically, as a joint means for coupling a suspension system of a vehicle and a subframe of a vehicle body, a rubber bush, a pillow ball bush, or the like are mounted on the end of an arm and a link, which constitute the suspension system.

The rubber bush or pillow ball bush serves to absorb an external force and vibration applied to the vehicle body due to any change in suspension geometry caused by a change in the position of the wheels during vehicle driving.

The rubber bush has a structure in which a vibration-proof rubber is disposed between inner and outer tubes. The rubber bush is continuously affected by a change in the surface of the road, i.e., a change in position, a change in distortion, etc., due to a change in geometry, and thus it is difficult to maintain the stiffness and durability of the rubber bush. However, the rubber bush has excellent damping properties.

The pillow ball bush is connected to either or both sides of each arm and link of the suspension system and, at the same time, mounted on the subframe of the vehicle body. Thus, the pillow ball bush can easily absorb an external force and vibration applied to the vehicle body to minimize the displacement of the vehicle body and has high lateral stiffness. However, the insulating and damping properties of the pillow ball bush are somewhat lower than those of the rubber bush, and thus it is difficult to provide an improved ride. Moreover, the pillow ball bushes currently in production have complex structures, and thus the manufacturing costs thereof are high.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a low-friction bush for vehicle with a new structure, which has both the advantages of a pillow ball bush and the primary functions of a rubber bush such as good insulating and damping properties, thereby providing a comfortable ride together with smooth movement of the wheels during vehicle driving.

In an aspect, the low-friction bush for a vehicle may include an inner pipe having a spherical portion being convex toward the outside, a bearing seat configured to be in rolling contact with an outer surface of the spherical portion of the inner pipe, wherein each entrance of the bearing seat may be spaced from the spherical portion of the inner pipe, a sealing member sealingly mounted between each end of the inner pipe and the entrance of the bearing seat, a plastic housing integrally injection-molded on an outer surface of the bearing seat and an outer surface of the sealing member, an outer pipe spaced from an outer circumference of the plastic housing, and a vibration-proof rubber filled in a space between the outer pipe and the plastic housing to integrate the outer pipe and the plastic housing.

The spherical portion may be formed to be convex toward the outside,

The sealing member may include a dust cover including an outer end on which a first steel ring being in close contact with an outer circumference of the each end in the inner pipe, and an inner end being in close contact with the entrance of the bearing seat, and a second steel ring, an end thereof being installed in a circumferential groove formed on an outer circumference of the inner end in the dust cover, and the other end thereof being integrally injection-molded with the plastic housing.

The second steel ring may include a saw-toothed portion formed on an outer circumference thereof such that the second steel ring may be bonded to the plastic housing during injection molding of the plastic housing.

The bearing seat may include a plurality of line grooves formed on the outer surface of the bearing seat such that the bearing seat may be bonded to the plastic housing during injection molding of the plastic housing, wherein the plurality of line grooves may be formed on the outer surface of the bearing seat in a longitudinal axis of the bearing seat.

The bearing seat may be made up of a plastic or polymer resin.

Other aspects and preferred embodiments of the invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIGS. 1A-1C are diagrams showing the manufacturing sequence of a low-friction bush for vehicle in accordance with an embodiment of the present invention.

FIG. 2 is a cross-sectional view showing a low-friction bush for vehicle in accordance with an embodiment of the present invention.

Reference numerals set forth in the Drawings includes reference to the following elements as further discussed below,

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The present invention provides a low-friction bush for vehicle with a new structure, which is pressingly connected to an arm or link of a suspension system and, at the same time, connected to a subframe of a vehicle body, the low-friction bush of the present invention having both the functions of existing pillow ball bush and rubber bush.

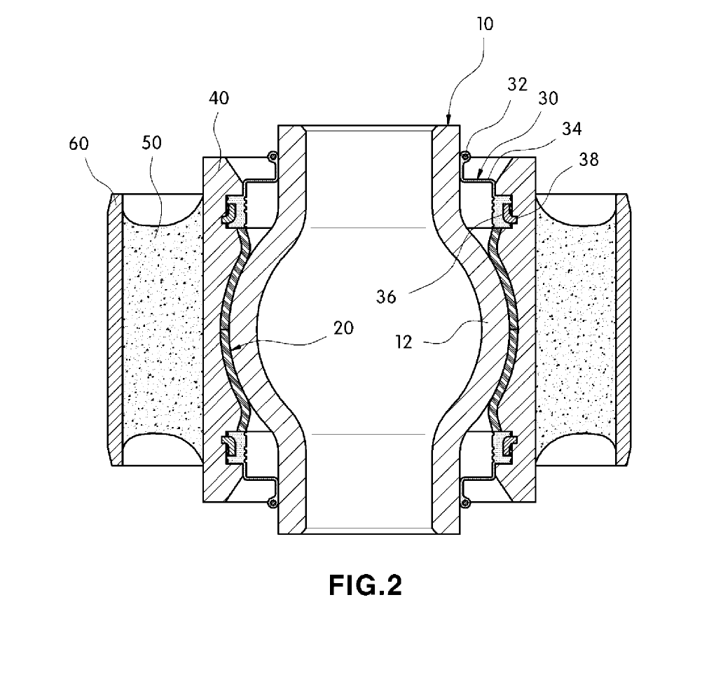

As shown in FIG. 2, the low-friction bush of the present invention is a component to serve as a pillow ball and includes an inner pipe 10 and a bearing seat 20.

The inner pipe 10 has a structure in which a spherical portion 12 is formed in the middle to be convex toward the outside and both ends thereof are formed in a straight pipe shape. The bearing seat 20 is formed into a cylindrical structure using a plastic or polymer resin material having low friction properties and high flexibility, the cylindrical structure being formed by coupling a pair of hemispherical bodies.

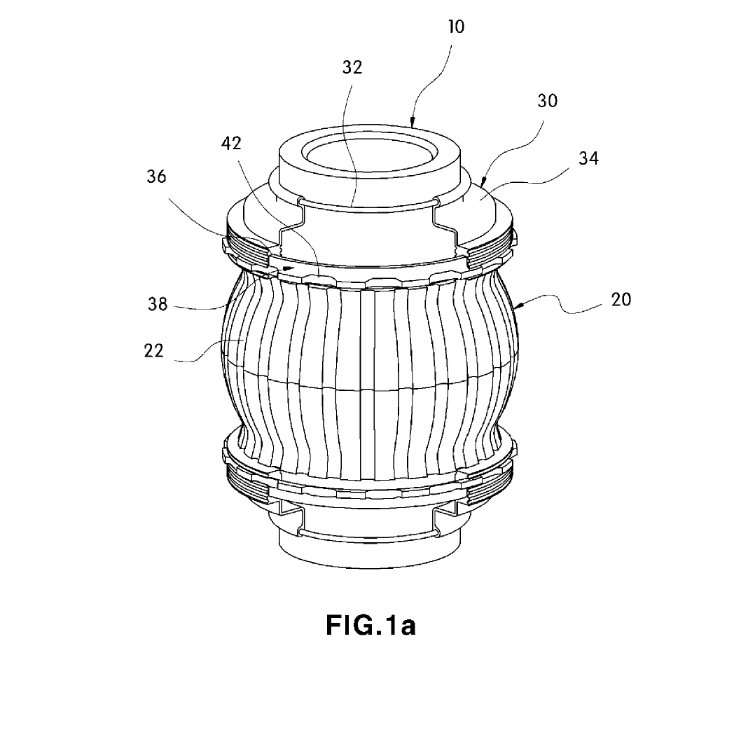

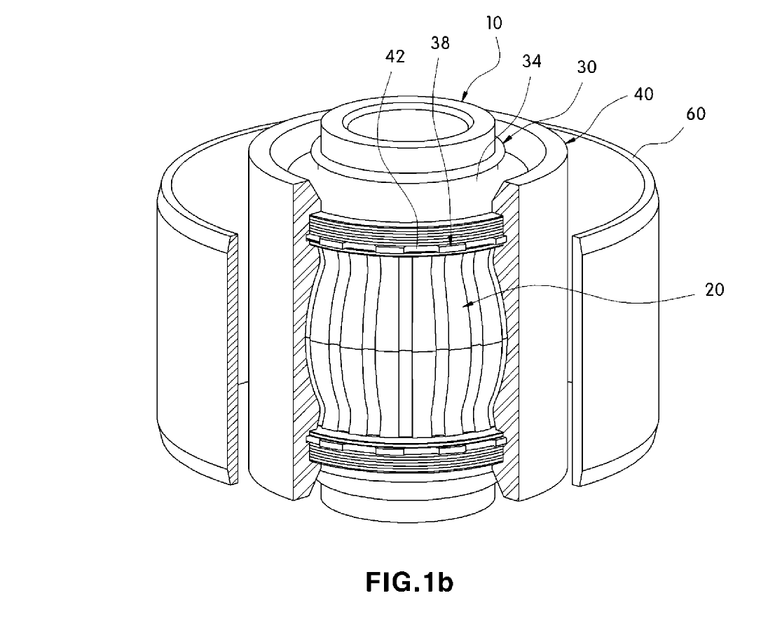

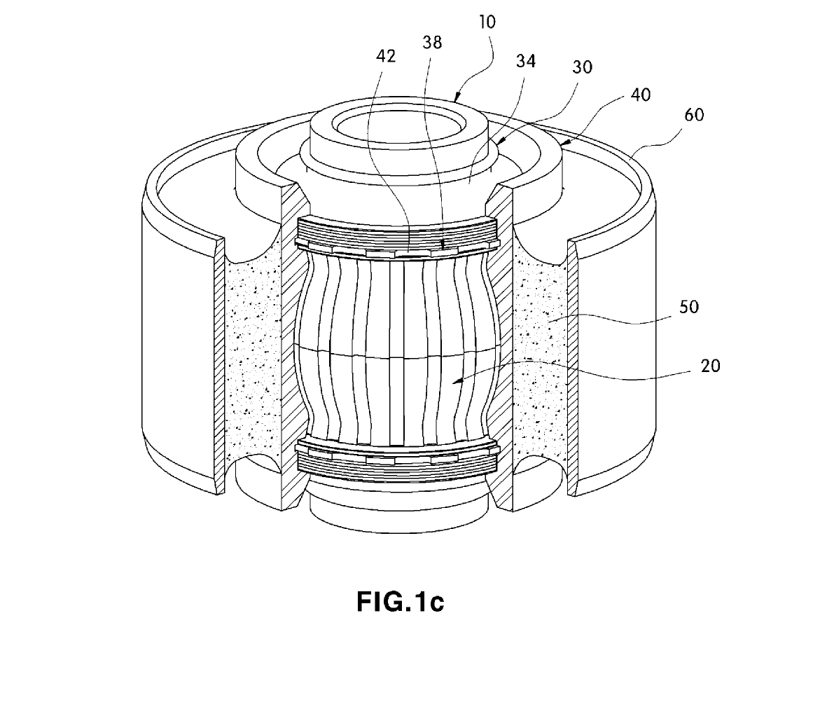

Thus, as shown in FIG. 1A, when the bearing seat 20 including the pair of hemispherical bodies is in close contact with the outer circumference of the inner pipe 10, the hemispherical bodies of the bearing seat 20 are in rolling contact with the outer surface of the spherical portion 12 of the inner pipe 10, and the entrance (i.e., each end) of the bearing seat 20 is spaced from a boundary between the spherical portion 12 of the inner pipe 10 and the straight pipe.

As the spherical portion 12 of the inner pipe 10 and the bearing seat 20 are in rolling contact with each other in the above-described manner, the spherical portion 12 and the bearing seat 20 can rotate and move conically relative to each other, like a ball joint portion of an existing pillow ball bush. In particular, as the spherical portion 12 is brought into contact with the bearing seat 20 of a low-friction material, the rotation and conical movement relative to each other can be achieved with a minimal friction.

Here, as shown in FIG. 1A, in order to prevent foreign substances from entering the space between the inner pipe 10 and the bearing seat 20, i.e., the inner space where the rolling contact is provided, a sealing member 30 is sealingly mounted between the outer circumference of each end of the inner pipe 10 and the entrance of the bearing seat 20.

The sealing member 30 includes a dust cover 34 including a first steel ring 32 put on the outer end of the dust cover 34 and a second steel ring 38 put on the inner end thereof.

In more detail, the outer end of the dust cover 34 has a small-diameter portion which is in close contact with the outer circumference of each end of the inner pipe 10, and the inner end of the dust cover 34 has a large-diameter portion which is in close contact with the entrance (i.e., each end) of the bearing seat 20. Especially, the first steel ring 32 is elastically put in contact with the outer circumference of the inner pipe 10, and the second steel ring 38 integrally injection-molded with a plastic housing 40 is put on a circumferential groove 36 formed on the outer circumference of the inner end of the dust cover 34.

Thus, the space between the inner pipe 10 and the bearing seat 20, i.e., the inner space where the rolling contact is provided is sealed by the dust cover 34.

After the bearing seat 20 is mounted on the inner pipe 10 and the dust cover 34 is attached thereto in the above-described manner, the plastic housing 40 is integrally injection-molded on the outer surface of the bearing seat 20 and the outer surface of the sealing member 30 as shown in FIG. 1B.

Here, a plurality of line grooves 22 are formed on the outer surface of the bearing seat 20, on which the plastic housing 40 is integrally injection-molded, such that the injection molding material of the plastic housing 40 enters the line grooves 22, thereby further increasing the adhesion between the plastic housing 40 and the bearing seat 20.

Moreover, the circumference of the second steel ring 38, on which the plastic housing 40 is integrally injection-molded, has a saw-toothed portion 42 such that the injection molding material of the plastic housing 40 enters the saw-toothed portion 42, thereby further increasing the adhesion between the plastic housing 40 and the second steeling ring 38.

After the process of injection-molding the plastic housing 40, a straight outer pipe 60 is spaced from the outer circumference of the plastic housing 40 as shown in FIG. 1B. Then, as shown in FIG. 1C, a rubber solution for formation of a vibration-proof rubber 50 is injected between the plastic housing 40 and the outer pipe 60 and allowed to be cured such that the vibration-proof rubber 50 and the outer pipe 60 are integrally formed on the outer circumference of the plastic housing 40.

According to the low-friction bush for vehicle of the present invention manufactured in the above-described manner, the outer pipe 60 will be inserted into a mounting hole formed in an arm or link of a suspension system, and the inner pipe 10 will be connected to a subframe of a vehicle body via a bracket. As a result, the spherical portion 12 of the inner pipe 10 and the bearing seat 20 can rotate and move conically relative to each other, like a ball joint portion of an existing pillow ball bush, and at the same time, the vibration-proof rubber 50 formed between the plastic housing 40, integrally formed on the bearing seat 20, and the outer pipe 60 performs a damping function like an existing rubber bush.

As described above, the present invention provides the following effects.

The bearing seat of the low-friction bush for vehicle according to an exemplary embodiment of the present invention is brought into rolling contact with the spherical portion of the inner pipe to perform the functions of an existing pillow ball bush, and the vibration-proof rubber is disposed in the space between the plastic housing, which is integrally injection-molded on the bearing seat, and the outer pipe to perform the damping function of an existing rubber bush. As a result, the low-friction bush for vehicle of the present invention has both the advantages of the existing pillow ball bush and rubber bush.

Moreover, the plastic housing is integrally injection-molded on the outer surface of the bearing seat, unlike the existing pillow ball bush formed of steel, and thus it is possible to reduce the material and manufacturing costs.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A low-friction bush for a vehicle, comprising:
an inner pipe having a spherical portion being convex toward the outside;
a bearing seat configured to be in rolling contact with an outer surface of the spherical portion of the inner pipe, wherein each entrance of the bearing seat is spaced from the spherical portion of the inner pipe;
a sealing member sealingly mounted between each end of the inner pipe and the entrance of the bearing seat;
a plastic housing integrally injection-molded on an outer surface of the bearing seat and an outer surface of the sealing member;
an outer pipe spaced from an outer circumference of the plastic housing; and
a vibration-proof rubber filled in a space between the outer pipe and the plastic housing to integrate the outer pipe and the plastic housing.

2. The low-friction bush for vehicle of claim 1, wherein the spherical portion is formed to be convex toward the outside;

3. The low-friction bush for vehicle of claim 1, wherein the sealing member includes:
a dust cover including:
an outer end on which a first steel ring being in close contact with an outer circumference of the each end in the inner pipe; and
an inner end being in close contact with the entrance of the bearing seat; and
a second steel ring, an end thereof being installed in a circumferential groove formed on an outer circumference of the inner end in the dust cover, and the other end thereof being integrally injection-molded with the plastic housing.

4. The low-friction bush for vehicle of claim 3, wherein the second steel ring includes a saw-toothed portion formed on an outer circumference thereof such that the second steel ring is bonded to the plastic housing during injection molding of the plastic housing.

5. The low-friction bush for vehicle of claim 1, wherein the bearing seat includes a plurality of line grooves formed on the outer surface of the bearing seat such that the bearing seat is bonded to the plastic housing during injection molding of the plastic housing.

6. The low-friction bush for vehicle of claim 5, wherein the plurality of line grooves is formed on the outer surface of the bearing seat in a longitudinal axis of the bearing seat.

7. The low-friction bush for vehicle of claim 1, wherein the bearing seat is made up of a plastic or polymer resin.
